(19) United States
(12) Patent Application Publication
(10) Pub. No.: US 2016/0320028 A1
(43) Pub. Date: Nov. 3, 2016

(54) Mechanical Attachment For Adjustable LED Light Engines

(71) Applicant: Jason Quentin Paulsel, Peachtree City, GA (US)

(72) Inventor: Jason Quentin Paulsel, Peachtree City, GA (US)

(21) Appl. No.: 14/701,296

(22) Filed: Apr. 30, 2015

(51) Int. Cl. F21V 17/02; F21V 19/02; F21V 23/00; F21V 29/70; F21S 8/02

(52) U.S. Cl. CPC F21V 17/02; F21V 29/70; F21S 8/026; F21V 23/005; F21V 19/02; F21Y 2101/02

(57) ABSTRACT

A lighting device includes a heat sink and a swivel band having a groove around an outer surface of the swivel band. The lighting device further includes a light source attached to the heat sink. The light source is oriented to emit light through an area surrounding by the swivel band. The lighting device also includes a tilt bracket attached to the heat sink and to the swivel band. The heat sink and the heat sink are tiltable relative to a vertical axis.

### TECHNICAL FIELD

The present disclosure relates generally to lighting fixtures, and more particularly to tiltable and rotatable lighting devices.

### BACKGROUND

Some light fixtures are designed for recessed mounting behind, for example, a ceiling. With some recessed light fixtures, once the light fixture is installed, adjustment of the direction of light from the light source of the light fixture may be challenging. Further, some light fixtures that provide the capability to adjust the direction of light from recessed light fixtures may be relatively expensive. In some cases, installation of recessed light fixtures that may be adjusted to provide a desired direction of light emission may also be challenging.

Thus, a lighting device that allows customer installation with the lighting device with capability to adjust the rotational and tilt position of the light source at a reasonable cost may be desirable.

### SUMMARY

The present disclosure relates to adjustably mounting a luminaire or retrofitting a luminaire with an adjustable mounting device. In an example embodiment, a lighting device includes a heat sink and a swivel band having a groove around an outer surface of the swivel band. The lighting device further includes a light source attached to the heat sink. The light source is oriented to emit light through an area surrounding by the swivel band. The lighting device also includes a tilt bracket attached to the heat sink and to the swivel band. The heat sink and the heat sink are tiltable relative to a vertical axis.

In another example embodiment, a lighting device includes a collar and a light engine comprising a heat sink, a light source attached to the heat sink, and a swivel band having a groove around an outer surface of the swivel band. The swivel band is positioned within a cavity of the collar. The swivel band is rotatable relative to the collar. A tilt bracket is attached to the heat sink and to the swivel band. The heat sink and the light source are tiltable relative to a vertical axis.

In another example embodiment, a lighting fixture includes a housing and a collar attached to the housing. The collar is positioned in a cavity of the housing. The lighting fixture further includes a light engine comprising a heat sink, a light source attached to the heat sink, and a swivel band having a groove around an outer surface of the swivel band. The swivel band is positioned within a cavity of the collar. The swivel band is rotatable relative to the collar. The lighting fixture also includes a tilt bracket attached to the heat sink and to the swivel band. The heat sink and the light source are tiltable relative to a vertical axis.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a tiltable and rotatable lighting device according to an example embodiment;

FIG. 2 illustrates a cross-sectional view of the lighting device of FIG. 1 according to an example embodiment;

FIG. 3 illustrates a light fixture including a cross-sectional view of the lighting device of FIG. 1 positioned in a housing according to an example embodiment.

FIG. 4 illustrates the light fixture of FIG. 3 including a cross-sectional view of the lighting device of FIG. 1 positioned in a housing according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DESCRIPTION OF EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

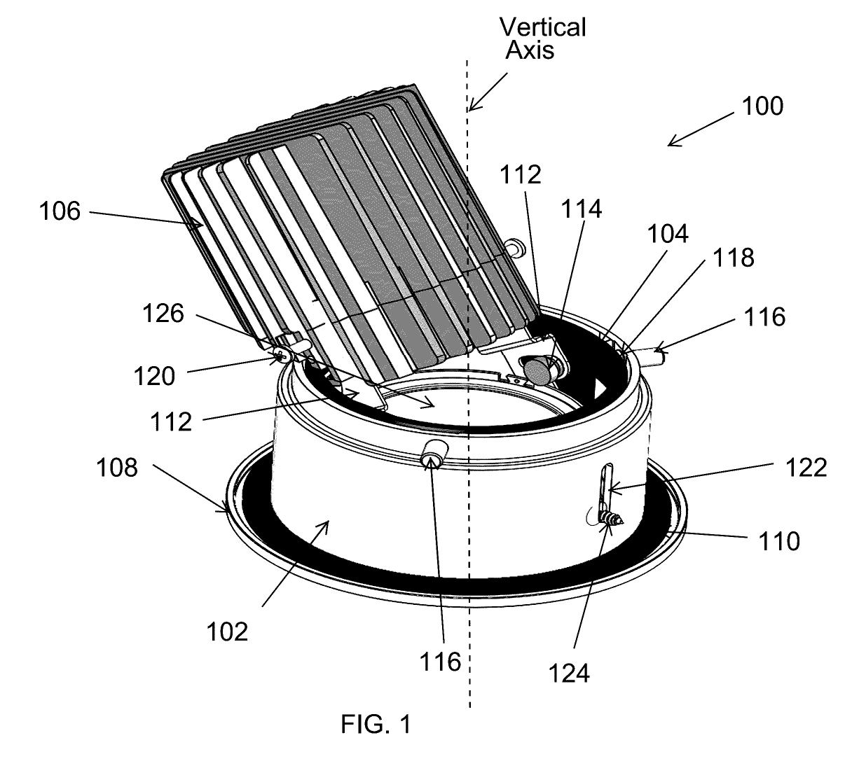

FIG. 1 illustrates a tiltable and rotatable lighting device 100 according to an example embodiment. In some example embodiments, the lighting device 100 includes a swivel band 104 and a heat sink 106. The swivel band 104 is positioned within a cavity of a collar 102. In some example embodiments, the lighting device 100 includes tilt brackets 112. Each tilt bracket 112 may be attached to the swivel band 104 and to the heat sink 106. For example, each tilt bracket 112 may be fixedly attached to the heat sink 106 by a respective screw 120.

As shown in FIG. 1, a respective screw 114 (e.g., a thumb screw) may be used to attach each tilt bracket 112 to the swivel band 104. For example, the screws 114 may attach the tilt bracket 112 to the swivel band 104 at diametrically opposite sides of the swivel band 104. Each screw 114 may extend through a respective slot in the respective tilt bracket 112 to attach the tilt bracket 112 to the respective swivel band 104.

The relative tilt position of the heat sink 106 to the swivel band 104 may be changed by changing positions of the tilt brackets 112 relative to the swivel band 104. To illustrate, the screws 114 may be loosened to change the relative position of the tilt brackets 112 to the swivel band 104, which results in a change in the relative tilt position of the heat sink 106 to the swivel bracket 104. In general, a position of each tilt bracket 112 may be changed by loosening the screws 114, moving the tilt brackets 112 to a desired position relative to the Vertical Axis, and tightening the screws 114 to retain the tilt brackets 112 at the new position. Because the tilt brackets 112 are fixedly attached to the heat sink 106, the position of the heat sink 106 relative to the Vertical Axis may be changed by changing the positon of the tilt brackets 112 relative to the Vertical Axis.

By changing the tilt position of the heat sink 106, a relative tilt position of a light source that is attached to the heat sink 106 may be changed. To illustrate, a light source may be attached to the heat sink 106 and oriented to emit light through the swivel band 104. Thus, the direction of the light emitted by the light source through the area 126 surrounded by the swivel band 104 may be changed by changing the tilt positon of the heat sink 106 relative to the swivel band 104.

In some example embodiments, the lighting device 100 includes ball catches 116. The ball catches 116 may serve to retain the swivel band 104 within the cavity collar 102. To illustrate, each ball catch 116 includes a ball 118 that is positioned in a groove of the swivel band 104. The ball catches 116 exert a force on the swivel band 104 via the balls positioned in the groove to retain the swivel band 104 in a vertical position relative to the collar 102.

In some example embodiments, the swivel band 104 may be removed from the collar 102, for example, by pulling down the swivel band 104 with adequate force. For example, the swivel band 104 may be removed from the collar 102 by exerting a force that is greater than approximately 5 pounds.

In some example embodiments, the groove of the swivel band 104 extends around the outer perimeter of the swivel band 104 (i.e., on the outer surface of the swivel band 104) such that the swivel band 104 is rotatable relative to the collar 102. For example, the swivel band 104 may be rotatable 360 degrees in both clockwise and counterclockwise directions. In general, the tilt bracket 112 and the heat sink 106 rotate along with the swivel band 104.

In some example embodiments, the lighting device 100 includes a trim ring 108 and a gasket 110 that is attached to the trim ring 108. As shown in FIG. 1, the gasket 110 may be positioned on a side of the trim ring 108 that faces away from an area illuminated by the lighting device 100. The trim ring 108 may be positioned around an opening of a ceiling and the gasket 110 may be disposed between the trim ring 108 and the ceiling.

In some example embodiments, the collar 102 may include a slot 122 and a screw 124 extending through the slot 122. The collar 102 may also include other slots similar to the slot 122 and respective screws extending through the slots. The screw 124 and the slot 122 may be used to securely attach the collar 102 to a structure such as a housing or a part of the trim ring 108 while allowing vertical adjustment of the collar 102. For example, the collar 102 may be vertically raised or lowered relative to the trim ring 108.

By positioning balls 118 of the ball catches 116 in the groove of the swivel band 104 and by attaching the tilt brackets 112 to the swivel band 104 and to the heat sink 106 in a manner described above, the heat sink 106 may be tilted relative to the swivel band 104 and may be rotated along with the swivel band 104. For example, the heat sink may be tilted up to approximately 35 degrees from the Vertical Axis, and may be rotatable 360 degrees along with the swivel band 104 that is rotatable within the collar 102.

The relative direction of light emitted by the light source that is attached to the heat sink 104 may be initially set by setting the tilt position of the heat sink 106 relative swivel band 104 and/or by setting the rotational position of the heat sink 106 relative to the collar 102. Also, the relative direction of light emitted by the light source that is attached to the heat sink 104 may be changed by changing the tilt position of the heat sink 106 relative swivel band 104 and/or by changing the rotational position of the heat sink 106 relative to the collar 102. As described above, the rotational position of the heat sink 106 relative to the collar 102 may be changed by changing the rotational position of the swivel band 104 relative to the collar 102.

In some example embodiments, the collar 102, the swivel band 104, and the heat sink 106 may be made from aluminum or another suitable material using die casting or other methods as may be contemplated by those of ordinary skill in the art with the benefit of this disclosure. The tilt bracket 112 and other components may also be made from aluminum or other suitable material in a similar manner.

Although the swivel band 104 is shown in FIG. 1 as being positioned substantially within the collar 102, in some alternative embodiments, the swivel band 104 may be partially positioned outside of the collar 102. Further, in some example embodiments, the swivel band 104 may be rotatable less than 360 degrees relative to the collar 102. In some example embodiments, the slots 122 and/or the screws 124 may be omitted. Further, the tilt brackets 112 may be attached to the heat sink 106 at a different location and in a different manner than shown in FIG. 1 without departing from the scope of this disclosure. The heat sink 106 may also have a different shape than shown in FIG. 1 without departing from the scope of this disclosure.

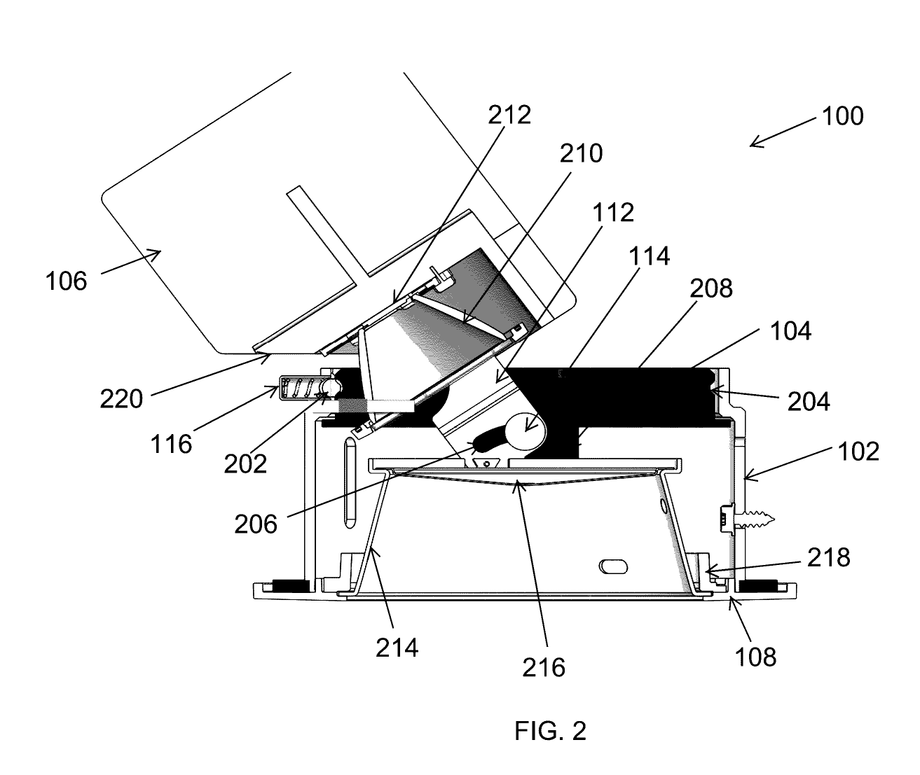

FIG. 2 illustrates a cross-sectional view of the lighting device of FIG. 1 according to an example embodiment. As shown in FIG. 2, the lighting device 100 includes the swivel band 104 disposed within the cavity of the collar 102. The swivel band 104 includes a groove 204 that is on the outer surface of the swivel band 104. For example, the groove 204 may extend around the entire outer perimeter of the swivel band 104.

As shown in FIG. 2, the ball catch 116 may include a ball 202 that is positioned in the groove 204. As described with respect to FIG. 1, multiple ball catches 116 (e.g., three ball catches) may be attached to the collar 102 such that the ball 202 of each catch is positioned in the groove 204 of the swivel band 104. For example, the ball catches 116 may be disposed approximately equal distance from each other around the collar 102. In general, the ball 202 of each ball catch 116 may be held in the groove 204 by a respective spring in each ball catch 116 that exerts a force toward the swivel band 104. The ball catches 116 allow the swivel band 104 to rotate within the collar 102 while providing adequate force to retain the swivel band 104 within the collar 102 because of the positioning of the balls 202 in the groove 204. To illustrate, the ball catches 116 may provide adequate force to carry the weight of the light engine, which includes the swivel band 104, the heat sink 106, a light source 212, and other components. In some example embodiments, the ball catches 116 may counteract up approximately 5 pounds of downward force to retain the swivel band 104 within the cavity of the collar 102. In some example embodiments, approximately a downward force in excess of 5 pounds may be adequate to remove the swivel band 104 from the collar 102.

In some example embodiments, the lighting device 100 includes the light source 212 that is attached to the heat sink 106. For example, the light source 212 may be one or more light emitting diodes (LEDs). To illustrate, the light source 212 may be one or more discrete LED dies, one or more LED packages, an array of LEDs, such as an LED strip, one or more LED chip on board devices, an organic LED, or another type of light source. The light source 212 may be attached to the heat sink 106 such that positional change of the heat sink 106 relative to the swivel band 104 results in positional change of the light source 212 relative to the swivel band 104. For example, by changing the tilt position of the heat sink 106 relative to the Vertical Axis shown in FIG. 1, the direction of light emitted by the light source 212 through the area 126 surrounded by the swivel band 104 may be changed.

In some example embodiments, the lighting device 100 may also include a beam forming optic 210. As shown in FIG. 2, the beam forming optic 210 may be positioned to direct light from the light source 212 toward an area below the lighting device 100. The beam forming optic 210 may be attached to the heat sink 106 or to the light source 212 (e.g., to the printed circuit board of the light source 212).

In some example embodiments, the swivel band 104 includes an elongated section 208 that extends down from the rest of the swivel band 104 and an another elongated section on the opposite side of the swivel band 104 across from the elongated section 208 and that extends down from the swivel band in a similar manner. For example, the elongated section 208 may extend down for attachment to a trim adapter 218. The trim adapter 218 may be attached to the elongated section 208 of the swivel band 104 using a means as may be contemplated by those of ordinary skill in the art with the benefit of this disclosure. For example, the trim adapter 218 and the elongated sections may be threaded such that the trim adapter 218 may be screwed onto the elongated section 208 and the opposing threaded section. In some alternative embodiments, the elongated section 208 may be omitted, and the trim adapter 218 may be coupled to another section of the swivel band 104 or to the collar 102.

In some example embodiments, the trim ring 108 may be attached to the trim adapter 218, for example, using matching threads of the trim ring 108 and the trim adapter 218. Because the trim adapter 218 is attached to the swivel band 104 or to the collar 102 as described above, the trim ring 108 may be secured to the swivel band 104 by attaching the trim ring 108 to the trim adapter 218. In alternative embodiments, the trim ring 108 may be attached to the trim adapter 218 by other means as may be contemplated by a person of ordinary skill in the art with the benefit of this disclosure.

In some example embodiments, the lighting device 100 includes a reflector 214 and a lens 216 that is attached to the reflector 214. Light from the light source 212 may be directed toward the area below the light source 212 through the lens 216. The lens 216 may be a diffusing lens or another kind of lens. In some example embodiments, the reflector 214 may be secured by sandwiching a lip of the reflector 214 between the trim ring 108 and the trim adapter 218. In some alternative embodiments, the reflector 214 may be attached to the trim ring 108 or another component of the lighting device 100.

As illustrated in FIG. 2, the tilt bracket 112 is attached to the swivel band 104 and to the heat sink 106. The tilt bracket 112 is attached to the swivel band 104 by the screw 114. The screw 114 extends through an arcuate slot 206 in the tilt bracket 112 to attach the tilt bracket 112 to the swivel band 104. For example, the screw 114 may be tightened such that the head of the screw 114 presses against the tilt bracket 112 to securely attach the tilt bracket 112 to the swivel band 104 in a particular tilt position relative to the swivel band 104. The tilt position of the tilt bracket 112 relative to the swivel band 104 may be changed by first loosening the screw 114, changing the position of the screw 114 within the arcuate slot 206 by moving the tilt bracket 112, and tightening back the screw 114. In some example embodiments, the tilt position of the tilt bracket 112 relative to the swivel band 104 may be changed by rotating the tilt bracket 112 without changing the position of the screw 114 within the arcuate slot 206. In general, the tilt position of each bracket 112 of the lighting device 100 may be changed in a similar manner.

As described above with respect to FIG. 1, each tilt bracket 112 may be attached to the heat sink 106 in a fixed position, for example, by the screw 120 as shown in FIG. 1. Thus, changing the tilt position of the tilt bracket 112 relative to the swivel band 104 results in a change of the tilt position of the heat sink 106 relative to the Vertical Axis shown in FIG. 1. Further, because the light source 212 may be attached to the heat sink 106, changing the tilt position of the heat sink 106 relative to the Vertical Axis can result in a directional change of the light emitted by the light source 212.

In some example embodiments, the tilt bracket 112 along with the heat sink 106 may be tilted approximately 35 degrees relative to the Vertical Axis. For example, moving the tilt bracket 112 such that the screw 114 is in the arcuate slot 206 as shown in FIG. 2 can allow the largest tilt angle of the tilt bracket 112 and the heat sink 106 along with the light source 212. In some example embodiments, positioning the screw 114 at the opposite end of the arcuate slot 206 (i.e., opposite the position shown in FIG. 2) by moving the tilt bracket 112 as described above can allow a vertical (i.e., no tilt) positioning of the tilt bracket 112 and the heat sink 106 along with the light source 212. In some example embodiments, the tilt bracket 112 may include tick marks to assist in positioning of the tilt bracket 112, and thus the heat sink 106 and the light source 212, at a desired tilt position.

Because the swivel band 104 can be rotated relative to the collar 102 as described above, the rotational positions of the heat sink 106 and the light source 212 can also be changed by rotating the swivel band 104. As described above, in some example embodiments, the swivel band 104 may be rotated 360 degrees in both clockwise and counterclockwise directions relative to the collar 102 while being retaining by the ball catches 116.

In some example embodiments, the heat sink 106 may have a slanted surface 220. To illustrate, the light source 212 may be attached to a bottom surface of the heat sink 106 such that light from the light source 212 is directed through the area 126 surrounding by the swivel band 104. The slanted surface 220 may extend from the bottom surface of the heat sink 106 to allow tilting of the heat sink 106 as described above. Because the heat sink 106 can be rotated as described above, the heat sink 106 has the slanted surface 220 on only one side of the heat sink 106, which allows a larger heat sink 106 without requiring a height or width increase of the heat sink 106 as compared to a lighting device that does not have a rotatable heat sink 106.

Although one tilt bracket 112 is shown, the second tilt bracket 112 shown in FIG. 1 may be attached to the swivel band 104 and adjusted in the similar manner. Further, the collar 102, the swivel band 104, the heat sink 106, and other components of the lighting device 100 may have shapes other than shown in FIG. 2 without departing from the scope of this disclosure. In some example embodiments, the trim adapter 208 may be omitted and the trim ring 108 may be attached to the collar 102 or another structure. In some alternative embodiments, the ball catches 116 may be omitted and friction springs or other means may be used to attach the swivel band 104 to the collar 102. For example, if rotation of the swivel band 104 is not needed, an attachment means that securely attaches the swivel band 104 to the collar 102 may be used while the tilt capability of the tilt bracket 112 is maintained.

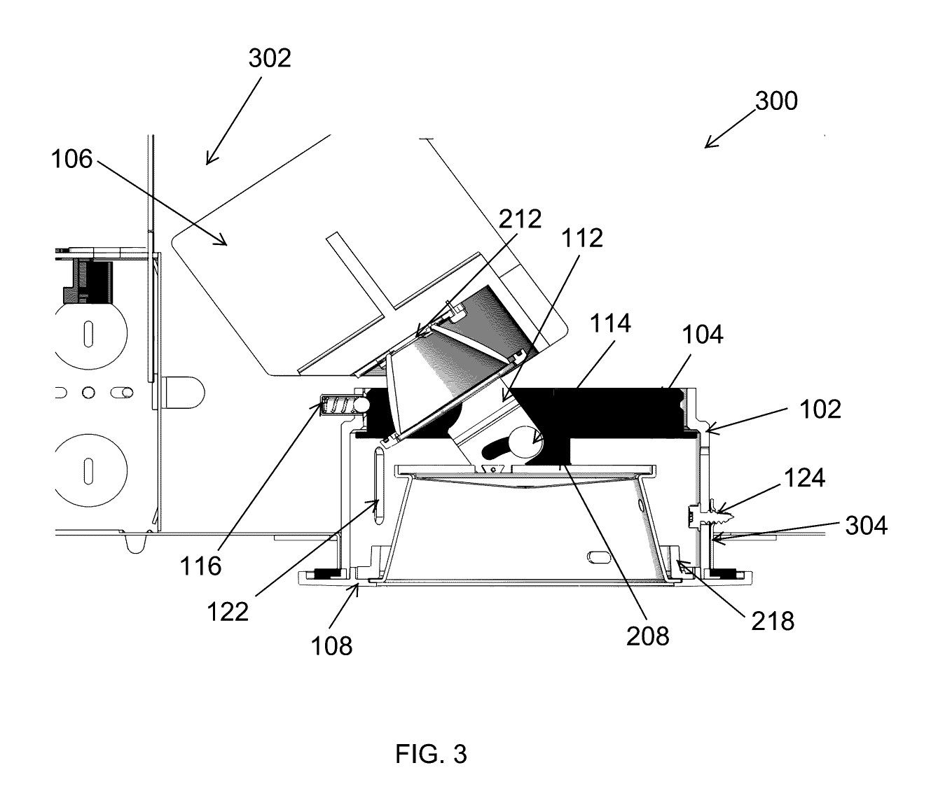

FIG. 3 illustrates the light fixture 300 including a cross-sectional view of the lighting device of FIG. 1 positioned in a housing 302 according to an example embodiment. Referring to FIGS. 1-3, the lighting fixture 300 includes a housing 302. For example, the housing may be disposed behind a ceiling (not shown). The lighting device 100 is disposed in the housing 302 such that the light source 212 and the heat sink 106 are tilted relative to the Vertical Axis shown in FIG. 1.

In some example embodiments, the heat sink 106 and the light source 212 may be tilted prior to being disposed in the housing 302. As described above, the heat sink 106 and the light source 212 may be tilted by loosening the respective screws 114, changing the tilt position of the tilt brackets 112, and tightening the screws 114 to fix the tilt position of the tilt bracket 112 relative to the swivel band 104. The light engine (i.e., the swivel band 104, the heat sink 106, the light source 212, etc.) may be rotated relative to the collar 102 prior to tilting heat sink 106 along with the light source 212. Alternatively, the light engine may be rotated after tilting heat sink 106 and the light source 212 as shown in FIG. 3.

In some alternative embodiments, the heat sink 106 and the light source 212 may be tilted after the lighting device 100 is positioned in the housing 302. The light engine (i.e., the swivel band 104, the heat sink 106, the light source 212, etc.) may be oriented to have a desired rotational position relative to the collar 102 and inserted into the housing 302 such that the heat sink 106 passes through the collar 102 while the swivel band 104 is retained in the collar 102 by the ball catches 116. The rotational position of the heat sink 106 may be adjusted by rotating the swivel band 104 relative to the collar 102 as described above. The tilt position of the heat sink 106 along with the light source 212 may then be adjusted using the screw 114 as described above. Additional adjustment of the rotational position of the heat sink 106 and the light source 212 may be performed after the tilt position of the heat sink 106 and the light source 212 is fixed.

In some example embodiments, the vertical position of the collar 102 may be adjusted by changing the position of the screw 124 relative to the slot 122 of the collar 102. To illustrate, the screw 124 may extend through the slot 122 (also shown in FIG. 1) and may be fastened into a bracket 304, which is stationary relative to the collar 102, to secure the collar 102. For example, the bracket 304 may be fixedly attached to the housing 302. By loosening the screw 124, the collar 102 may be moved up or down such that the vertical position of the screw 122 changes within the slot 122. After the collar 102 is moved to a desired vertical position, the screw 124 may be tightened to secure the collar 102.

In some example embodiments, after the light engine (i.e., the swivel band 104, the heat sink 106, the light source 212, etc.) is positioned such that the swivel band 104 is attached to the collar 102 and the light source 212 is oriented to emit light through the swivel band 104 in a desired direction, the elongated section 208 may be securely attached to the trim adapter 218 by a means such as one or more screws, clips, etc. For example, the trim adapter 218 and the trim ring 108 that is attached to the trim adapter 218 as described above may be retained by attachment to the elongated section 208.

Although one screw 124 is shown in FIG. 3, the lighting fixture 100 may include more than one screw. In some alternative embodiments, the screw 124 may be omitted. For example, the collar 102 may be fixedly attached to the housing 302.

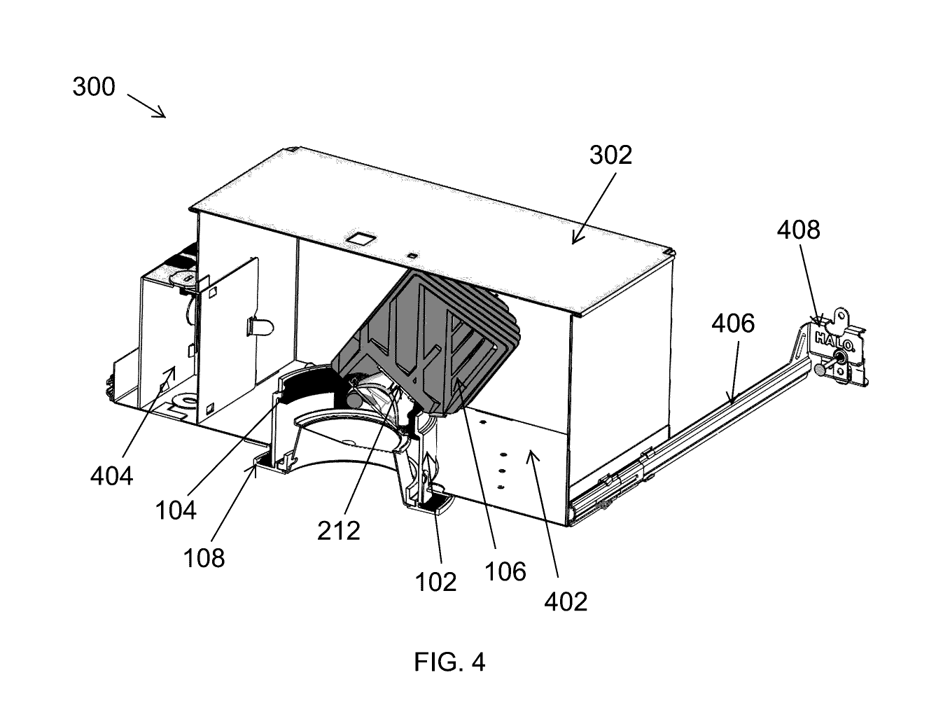

FIG. 4 illustrates the light fixture 300 including a cross-sectional view of the lighting device 100 of FIG. 1 positioned in the housing 302 according to another example embodiment. As illustrated in FIG. 4, the collar 102 and the heat sink 106 are positioned a cavity 402 of the housing 302, and the swivel band 104 is positioned in the cavity of the collar 102. The trim ring 108 is positioned below the housing 302. The heat sink 106 includes a box 404 that may be used for wire connections and/or a driver for the lighting device 100. The lighting device 100 is positioned in the housing 302 such that the light source 212 is oriented rotationally and angularly to emit light in a particular direction toward an area below the lighting fixture 100.

In some example embodiments, the light engine (i.e., the swivel band 104, the heat sink 106, the light source 212, etc.) may be pulled out through the collar 102 by pulling down on the swivel band 104. For example, the trim adapter 218 along with the reflector and the lens (shown in FIG. 2) may first be removed. For example, the trim ring 108 may be twisted of the trim adapter 208, and the trim adapter 208 may be detached from the swivel band 104. The swivel band 104 may then be pulled down with adequate force (e.g., greater than 5 pounds in some example embodiments) to remove the swivel band 104 and the heat sink 106 through the collar 102. In some example embodiments, the heat sink 106 may be adjusted to a vertical or s smaller tilt position before applying a force on the swivel band 104 to remove it from the collar 102. The collar 102 may be secured to the housing 302 such that the light engine may be removed through the collar 102 while the collar 102 remains attached to the housing 302.

In some example embodiments, the housing 302 may be attached to a structure such as a ceiling structure using a hanger bar 406, which may be adjustable in length, and an attachment structure 408. In some alternative embodiments, other types of hanger bars and attachment structures may be used to attach the lighting fixture 300 to a ceiling structure or to another structure.

The rotatability and tiltability of the light source 212 non-explosive tension release actuation device 100 described above allows consumers to install and/or adjust lighting device 100. The ability to adjust the rotational and tilt positions of the light source 212 prior to installation or after installation gives consumers flexibility in the installation and adjustment of the lighting device 100.

Although particular embodiments have been described herein, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. A lighting device, comprising:
a heat sink;
a swivel band having a groove around an outer surface of the swivel band;
a light source attached to the heat sink, wherein the light source is oriented to emit light through an area surrounding by the swivel band; and
a tilt bracket attached to the heat sink and to the swivel band, wherein the heat sink and the heat sink are tiltable relative to a vertical axis.

2. The lighting device of claim 1, further comprising a collar, wherein the swivel band is positioned in a cavity of the collar, wherein the swivel band is rotatable relative to the collar, and wherein heat sink and the light source are rotatable along with the swivel band.

3. The lighting device of claim 2, further comprising a plurality of ball catches attached to the collar, wherein a ball of each ball catch is positioned in the groove of the swivel band.

4. The lighting device of claim 3, wherein the ball catches retain the swivel band within the collar.

5. The lighting device of claim 2, wherein the swivel band is rotatable 360 degrees relative to the collar.

6. The lighting device of claim 1, wherein the tilt bracket has an arcuate slot and wherein a screw attaches the tilt bracket to the swivel band through the arcuate slot.

7. The lighting device of claim 6, wherein the heat sink positioned in a vertical position by positioning the screw at an end of the arcuate slot.

8. The lighting device of claim 6, wherein the heat sink is tiltable up to 35 degrees from the vertical axis with respect to the screw.

9. The lighting device of claim 1, wherein the light source includes to a printed circuit board and one or more light emitting diodes attached to the printed circuit board.

10. A lighting device, comprising:
a collar;
a light engine comprising a heat sink, a light source attached to the heat sink, and a swivel band having a groove around an outer surface of the swivel band, wherein the swivel band is positioned within a cavity of the collar and wherein the swivel band is rotatable relative to the collar; and
a tilt bracket attached to the heat sink and to the swivel band, wherein the heat sink and the light source are tiltable relative to a vertical axis.

11. The lighting device of claim 10, further comprising a plurality of ball catches attached to the collar, wherein a ball of each ball catch is positioned in the groove of the swivel band.

12. The lighting device of claim 10, wherein the ball catches retain the swivel band within the collar.

13. The lighting device of claim 10, wherein the swivel band is rotatable 360 degrees relative to the collar.

14. The lighting device of claim 13, wherein the heat sink is tiltable up to 35 degrees from a vertical axis with respect to a screw attaching the tilt bracket to the swivel band.

15. The lighting device of claim 10, wherein the light engine is sized to pass through the collar and wherein the swivel band is removable from the cavity of the collar by pulling the swivel band.

16. The lighting device of claim 10, wherein the tilt bracket has an arcuate slot and wherein a screw attaches the tilt bracket to the swivel band through the arcuate slot.

17. A lighting fixture, comprising:
a housing;
a collar attached to the housing, wherein the collar is positioned in a cavity of the housing;
a light engine comprising a heat sink, a light source attached to the heat sink, and a swivel band having a groove around an outer surface of the swivel band, wherein the swivel band is positioned within a cavity of the collar and wherein the swivel band is rotatable relative to the collar; and
a tilt bracket attached to the heat sink and to the swivel band, wherein the heat sink and the light source are tiltable relative to a vertical axis.

18. The lighting fixture of claim 17, further comprising a plurality of ball catches attached to the collar, wherein a ball of each ball catch is positioned in the groove of the swivel band.

19. The lighting fixture of claim 17, wherein the swivel band is rotatable 360 degrees relative to the collar and wherein the heat sink is tiltable up to 35 degrees from a vertical axis.

20. The lighting fixture of claim 17, wherein the light engine is sized to pass through the collar and wherein the swivel band is removable from the cavity of the collar by pulling the swivel band.
